(19) United States
(12) Patent Application Publication
(10) Pub. No.: US 2019/0077309 A1
(43) Pub. Date: Mar. 14, 2019

(54) Automated License Plate System

(71) Applicants: Cruz Villalobos, II, Jurupa Valley, CA (US); Tina Villalobos, Jurupa Valley, CA (US)

(72) Inventors: Cruz Villalobos, II, Jurupa Valley, CA (US); Tina Villalobos, Jurupa Valley, CA (US)

(21) Appl. No.: 15/704,167

(22) Filed: Sep. 14, 2017

(51) Int. Cl. B60Q 1/56; G06F 3/147; B60R 13/10; G08G 1/017

(52) U.S. Cl. CPC B60Q 1/56; G08G 1/017; B60R 13/10; G06F 3/147

(57) ABSTRACT

An automated license plate system includes a license plate that may be mounted to a vehicle. A display unit is coupled to the license plate such that the display unit is visible to law enforcement. The display unit is in wireless communication with an extrinsic communication network. Thus, the display unit receives data pertaining to a yearly vehicle registration. The display unit displays indicia corresponding to the yearly vehicle registration. In this way the display unit may communicate to law enforcement whether the yearly vehicle registration is current.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to license plate devices and more particularly pertains to a new license plate device for PURPOSE.

### BRIEF SUMMARY OF THE INVENTION

An embodiment of the disclosure meets the needs presented above by generally comprising a license plate that may be mounted to a vehicle. A display unit is coupled to the license plate such that the display unit is visible to law enforcement. The display unit is in wireless communication with an extrinsic communication network. Thus, the display unit receives data pertaining to a yearly vehicle registration. The display unit displays indicia corresponding to the yearly vehicle registration. In this way the display unit may communicate to law enforcement whether the yearly vehicle registration is current.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of an automated license plate system according to an embodiment of the disclosure.

FIG. 2 is a back view of an embodiment of the disclosure.

FIG. 3 is a front view of an embodiment of the disclosure.

FIG. 4 is a perspective in-use view of an embodiment of the disclosure.

FIG. 5 is a schematic view of an embodiment of the disclosure.

### DETAILED DESCRIPTION OF THE INVENTION

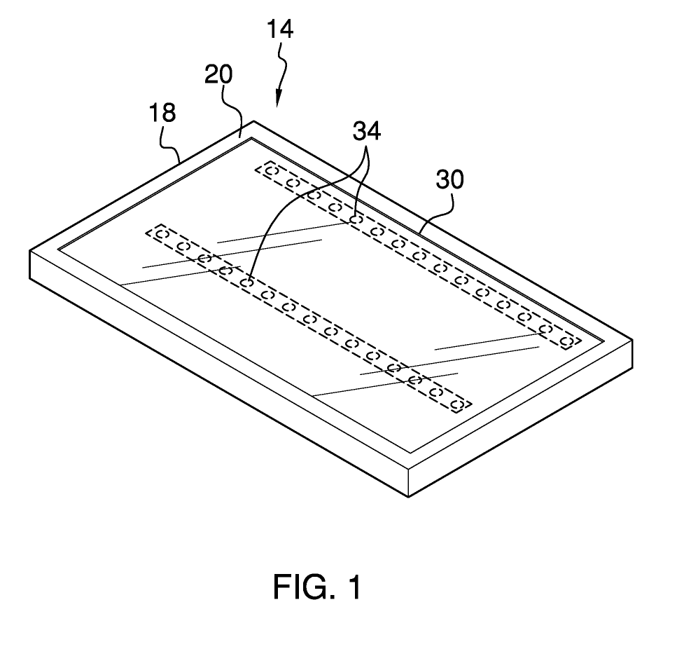

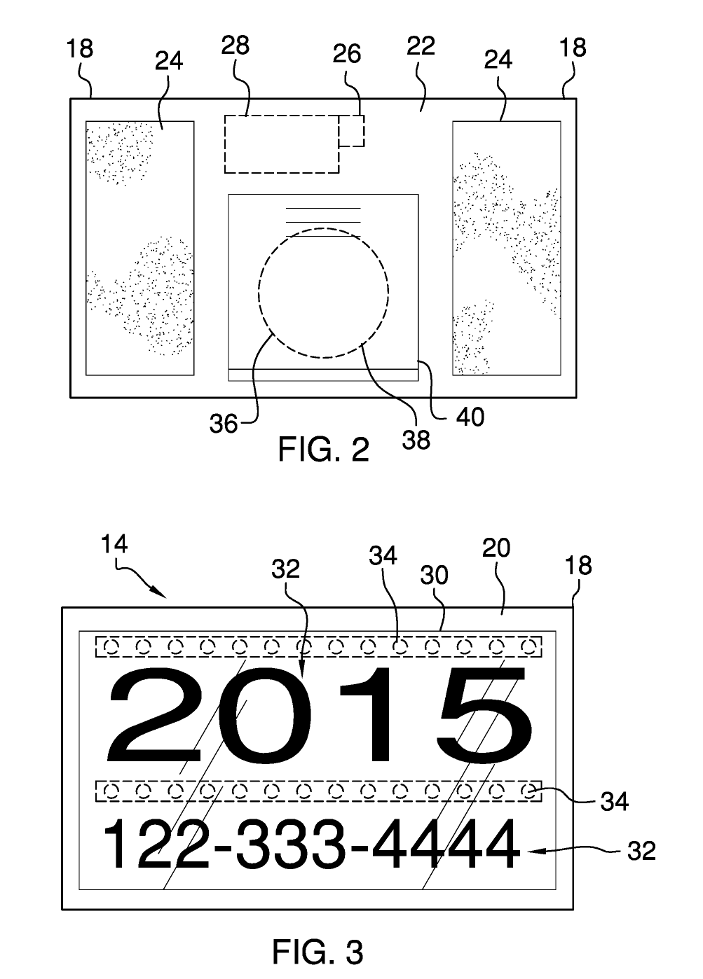

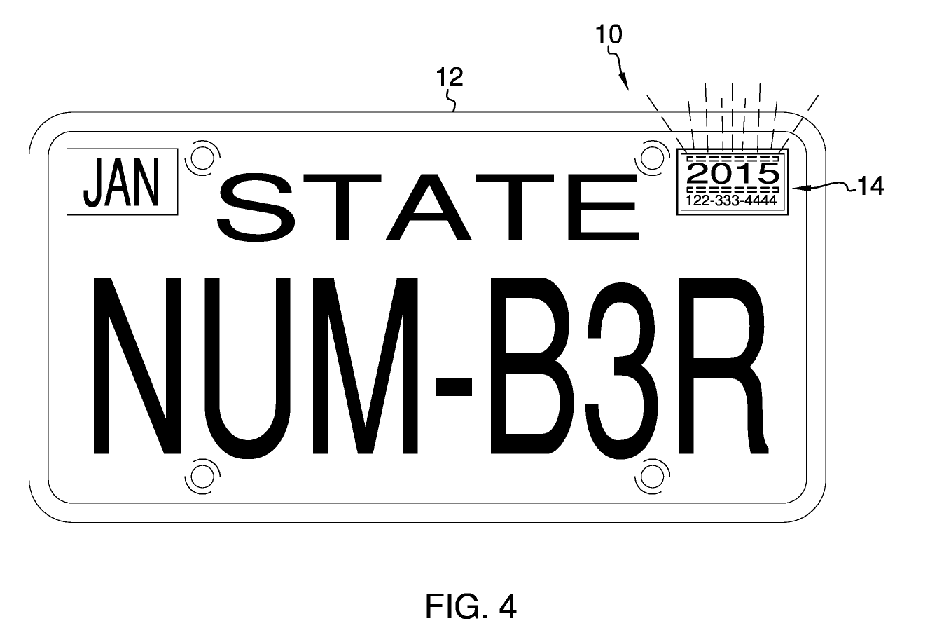

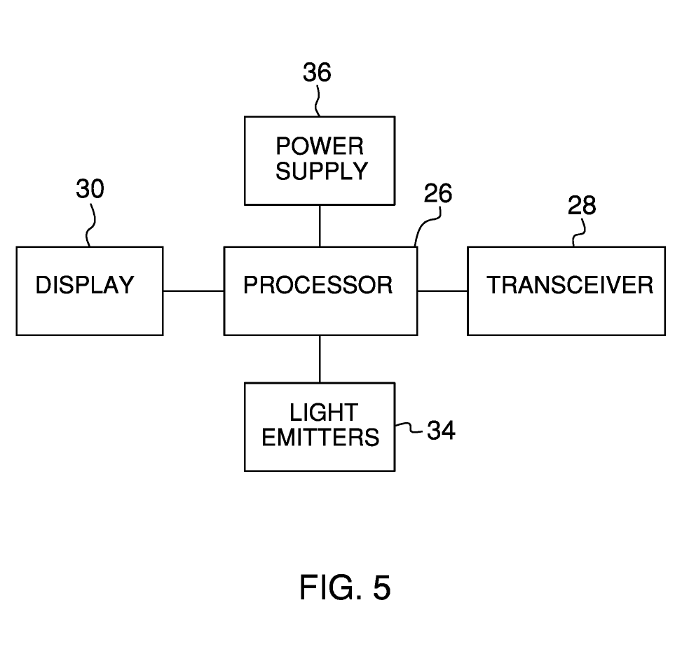

With reference now to the drawings, and in particular to FIGS. 1 through 5 thereof, a new license plate device embodying the principles and concepts of an embodiment of the disclosure and generally designated by the reference numeral 10 will be described.

As best illustrated in FIGS. 1 through 5, the automated license plate system 10 generally comprises a license plate 12 that may be mounted to a vehicle. The vehicle may be a passenger vehicle, a cargo vehicle and any other vehicle that is licensed to be driven on roadways. A display unit 14 is provided and the display unit 14 is coupled to the license plate 12. Thus, the display unit 14 is visible to law enforcement. The display unit 14 is in wireless communication with an extrinsic communication network 16 thereby facilitating the display unit 14 to receive data pertaining to a yearly vehicle registration. Moreover, the display unit 14 displays indicia corresponding to the yearly vehicle registration. In this way the display unit 14 communicates to law enforcement whether the yearly vehicle registration is current.

The display unit 14 comprises a housing 18 that has a front side 20 and a back side 22. A plurality of mating members 24 is provided and each of the mating members 24 is coupled to the back side 22. Each of the mating members 24 engages the license plate 12 to retain the housing 18 on the license plate 12. Each of the mating members 24 may comprise an adhesive strip or the like.

A processor 26 is positioned within the housing 18 and the processor 26 may be an electronic processor 26 or the like. The processor 26 may include an electronic memory that stores the license plate number corresponding to the license plate. A transceiver 28 is provided and the transceiver 28 is positioned within the housing 18. The transceiver 28 is electrically coupled to the processor 26. Moreover, the transceiver 28 is in electrical communication with the extrinsic communication network 16. The extrinsic communication network 16 may be the internet, a cellular phone network and any other wireless communication network. The transceiver 28 may be a radio frequency transceiver 28 and the transceiver 28 may employ a WPAN signal.

A display 30 is provided and the display 30 is coupled to the front side 20 of the housing 18 such that the display 30 is visible to law enforcement. The display 30 is electrically coupled to the processor 26. Additionally, the display 30 displays indicia 32 corresponding to a year of the vehicle registration and a serial number or the vehicle registration. The display 30 may comprise an LED or the like.

A plurality of light emitters 34 is provided and each of the light emitters 34 is coupled to the front side 20 of the housing 18. Each of the light emitters 34 emits light outwardly therefrom and each of the light emitters 34 is electrically coupled to the processor 26. Each of the light emitters 34 selectively emits a first color of light to communicate to law enforcement that the yearly vehicle registration is current. Each of the light emitters 34 selectively emits a second color of light to communicate to law enforcement that the yearly vehicle registration is expired. The first color of light may be green and the second color of light may be red. Each of the light emitters 34 may be an LED or the like.

A power supply 36 is provided and the power supply 36 is removably positioned in the housing 18. The power supply 36 is electrically coupled to the processor 26 and the power supply 36 comprises at least one battery 38. A battery cover 40 may be removably coupled to the housing 18. The power supply 36 may be positioned beneath the battery cover 40.

In use, the back side 22 of the housing 18 is adhered to the license plate 12. The transceiver 28 communicates the license plate number corresponding to the license plate 12 to the extrinsic communication network 16. The processor 26 turns the light emitters 34 on to emit the first color of light when the extrinsic communication network 16 confirms that the yearly registration is current. The processor 26 turns the light emitters 34 on to emit the second color of light when the extrinsic communication network 16 confirms that the yearly registration is expired. In this way law enforcement can quickly identify that status of a vehicle registration. Additionally, the processor 26 immediately turns the light emitters 34 on to emit the first color of light when the yearly registration is renewed.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. An automated license plate system comprising:
a license plate being configured to be mounted to a vehicle; and
a display unit being coupled to said license plate wherein said display unit is configured to be visible to law enforcement, said display unit being configured to be in wireless communication with an extrinsic communication network thereby facilitating said display unit to receive data pertaining to a yearly vehicle registration, said display unit displaying indicia corresponding to the yearly vehicle registration wherein said display unit is configured to communicate to law enforcement whether the yearly vehicle registration is current.

2. The system according to claim 1, wherein said display unit comprises:
a housing having a front side and a back side; and
a plurality of mating members, each of said mating members being coupled to said back side, each of said mating members engaging said license plate to retain said housing on said license plate.

3. The system according to claim 2, further comprising a processor being positioned within said housing.

4. The system according to claim 3, further comprising a transceiver being positioned within said housing, said transceiver being electrically coupled to said processor, said transceiver being configured to be in electrical communication with the extrinsic communication network.

5. The system according to claim 3, further comprising a display being coupled to said front side of said housing wherein said display is configured to be visible to law enforcement, said display being electrically coupled to said processor, said display displaying indicia corresponding to a year of the vehicle registration and a serial number or the vehicle registration.

6. The system according to claim 3, further comprising a plurality of light emitters, each of said light emitters being coupled to said front side of said housing wherein each of said light emitters is configured to emit light outwardly therefrom, each of said light emitters being electrically coupled to said processor.

7. The system according to claim 6, wherein each of said light emitters emits a first color of light wherein said plurality of light emitters is configured to communicate to law enforcement that the yearly vehicle registration is current.

8. The system according to claim 6, wherein each of said light emitters emitting a second color of light wherein said plurality of light emitters is configured to communicate to law enforcement that the yearly vehicle registration is expired.

9. The system according to claim 3, further comprising a power supply being coupled to said housing, said power supply being electrically coupled to said processor, said power supply comprising at least one battery.

10. An automated license plate system comprising:
a license plate being configured to be mounted to a vehicle; and
a display unit being coupled to said license plate wherein said display unit is configured to be visible to law enforcement, said display unit being configured to be in wireless communication with an extrinsic communication network thereby facilitating said display unit to receive data pertaining to a yearly vehicle registration, said display unit displaying indicia corresponding to the yearly vehicle registration wherein said display unit is configured to communicate to law enforcement whether the yearly vehicle registration is current, said display unit comprising:
a housing having a front side and a back side,
a plurality of mating members, each of said mating members being coupled to said back side, each of said mating members engaging said license plate to retain said housing on said license plate,
a processor being positioned within said housing,
a transceiver being positioned within said housing, said transceiver being electrically coupled to said processor, said transceiver being configured to be in electrical communication with the extrinsic communication network,
a display being coupled to said front side of said housing wherein said display is configured to be visible to law enforcement, said display being electrically coupled to said processor, said display displaying indicia corresponding to a year of the vehicle registration and a serial number or the vehicle registration,
a plurality of light emitters, each of said light emitters being coupled to said front side of said housing wherein each of said light emitters is configured to emit light outwardly therefrom, each of said light emitters being electrically coupled to said processor, each of said light emitters emitting a first color of light wherein said plurality of light emitters is configured to communicate to law enforcement that the yearly vehicle registration is current, each of said light emitters emitting a second color of light wherein said plurality of light emitters is configured to communicate to law enforcement that the yearly vehicle registration is expired, and
a power supply being coupled to said housing, said power supply being electrically coupled to said processor, said power supply comprising at least one battery.
